(19) United States
(12) Patent Application Publication
(10) Pub. No.: US 2024/0241889 A1
(43) Pub. Date: Jul. 18, 2024

(54) FRAMEWORK FOR BUILDING CLUSTER MANAGEMENT CONTROLLERS

(71) Applicant: VMware, Inc., Palo Alto, CA (US)

(72) Inventors: Lalith Suresh, Mountain View, CA (US); Xudong Sun, Urbana-Champaign, IL (US); Adriana Szekeres, Seatlle, WA (US)

(21) Appl. No.: 18/097,670

(22) Filed: Jan. 17, 2023

(51) Int. Cl. G06F 16/28

(52) U.S. Cl. CPC G06F 16/285

(57) ABSTRACT

Examples described herein include systems and methods for providing a framework for building and verifying cluster-management controllers. Using this framework, a developer can submit only a fraction of the code otherwise required to verify safety and liveness of a controller. A verification framework is provided that can verify the implementation of a cluster-management controller down to the manner it will execute. The developer can submit a small function that runs inside the provided framework, making formal verification possible. The framework provided to the developer can incorporate the complex details regarding standard portions of cluster-management controllers, the underlying platform (such as KUBERNETES, as an example), platform API, platform networking, and so on. The developer's code can therefore focus on the new features but still make use of formal verification for how that code will work within an entire cluster-management system.

### BACKGROUND

In cloud-based, distributed computing systems, clusters of computing devices can be used to accomplish various tasks with increased speed, power, and flexibility. Within these clusters, containerized applications can be leveraged in a manner that provides additional advantages. For example, a cluster can include a set of nodes that run containerized applications. The containerized applications can be packages of applications with their related dependencies and services. An example of such a cluster platform is KUBERNETES, although other types of cluster platforms exist with similar relevant functionalities.

A cluster platform can be used to automate deployment, scaling, and operations of application containers across one or more clusters. This control level of the platform is referred to herein as a “control plane.” A control plane can utilize microservices to perform various tasks within the platform. For example, the microservices can examine the current state of a cluster, or portion thereof, and compare it to a desired state. When the current state does not match the desired state, the microservices can make incremental changes to the system in order to move the system closer to the desired state. The microservices that perform these operations are referred to herein as “controllers.” Generally speaking, a controller performs a process of reconciling the cluster to conform to a particular desired state.

A cluster can utilize many different controllers that perform different functions. Ideally, each controller satisfies properties of safety and liveness. In this context, safety refers to avoiding a mistake such as accidentally deleting sensitive data, while liveness refers to the controller eventually performing its intended task. A good controller should have safety and liveness guarantees.

However, guaranteeing controller safety and liveness is difficult, and in some cases impossible, to test. This is due in part to an exponential number of potential scenarios to consider. In order for a developer to verify a controller, they would need to produce code for each detail relating not just to the controller, but to the underlying cluster platform itself. The magnitude of this task renders it impractical for real-world development, thereby discouraging development of new controllers and/or introducing unwanted bugs or errors into the system from untested controllers. These unguaranteed controllers have the potential to cause harm to existing networks and platforms, putting sensitive data and employee productivity at risk.

As a result, a need exists for new and improved frameworks for building cluster-management controllers that guarantee relevant safety and liveness properties.

### SUMMARY

Examples described herein include systems and methods for providing a framework for building and verifying cluster-management controllers. Using this framework, a developer can submit a fraction of the code otherwise required to verify safety and liveness of a controller. A verification framework is provided that can verify the implementation of a cluster-management controller down to the manner it will execute. The developer can submit a small function that runs inside the provided framework, making it possible for a developer to use formal verification when writing code for a cluster-management controller. The framework provided to the developer can incorporate the complex details regarding standard portions of cluster-management controllers, the underlying platform (such as KUBERNETES, as an example), platform Application Programming Interface (“API”), platform networking, and so on. The developer's code can therefore focus on the new features but still make use of formal verification for how that code will work within an entire cluster-management system.

In an example method, a verification framework can be provided for use by a developer. The verification framework can include multiple components. For example, the framework can include a shim layer that implements generic cluster-management controller functionality. This includes generic functionality that is common across cluster-management controllers for a particular platform, such as KUBERNETES or another cluster-management platform. The framework can also include various specifications describing the operations of different framework components.

For example, the framework can include a specification that describes the behavior of the shim layer mentioned above. It can also include a specification that describes the behavior of a control plane API for the platform at issue. Similarly, it can include a specification describing the network behavior of the cluster or platform. These specifications can include rich detail reflecting the underlying operations of the platform for which a developer wishes to develop a new cluster-management controller. Throughout this disclosure references are made to the KUBERNETES platform for illustrative purposes, but it should be understood that the teachings herein can be applied to any cluster-management platform.

The example method can also include receiving a developer package that includes various components relating to a cluster-management controller to be verified by the framework. For example, the developer package can include a reconciliation function that reflects an implementation of the cluster-management controller. The package can also include a specification that describes the behavior of the reconciliation function using formal logic, as well as one or more specified properties of the reconciliation function. In addition, the developer package can include at least one proof reflecting that the implementation of the cluster-management controller guarantees the specified properties.

The example method can include confirming that the specification received from the developer accurately describes the behavior of the reconciliation function that the developer provided. The example method can also include integrating the received specification into the verification framework to create an integrated verification framework. The integrated verification framework can then be submitted to a verifier tool for additional testing. For example, the integrated framework can be provided alongside the proof sent from the developer, and the verifier tool can examine the collective specifications within the integrated framework and determine whether it corresponds to the proof (or proofs) from the developer.

In a scenario where the verifier tool determines that the integrated verification framework does not correspond to the proof, the method can include indicating that one or more statements of the proof could not be proved. This can be submitted to the developer as an alert, for example. In an instance where the verifier tool determines that integrated verification framework corresponds to the proof, then the system can output a confirmation message. In some examples, the method can proceed to compiling an executable file linked to the shim layer and providing the executable to the developer.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a framework for building and verifying cluster-management controllers.

FIG. 2 is a sequence diagram of an example method for providing a framework for building and verifying cluster-management controllers.

FIG. 3 is a diagram of an example cluster-management controller implementing state reconciliation.

FIG. 4 is a diagram of an example cluster-management controller interfacing with components of an example KUBERNETES cluster.

FIG. 5 is a diagram showing components of an example framework for building and verifying cluster-management controllers.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

A good controller should have safety and liveness guarantees. In this context, safety refers to avoiding a mistake such as accidentally deleting sensitive data, while liveness refers to the controller eventually performing its intended task.

Examples described herein include systems and methods for providing a framework for building and verifying safety and liveness of cluster-management controllers. Using this framework, a developer can submit only a fraction of the code otherwise required to verify safety and liveness of a controller. A verification framework is provided that can verify the implementation of a cluster-management controller down to the manner it will execute. The developer can submit a small function that runs inside the provided framework, making it possible for a developer to use formal verification when writing code for a cluster-management controller. The framework provided to the developer can incorporate the complex details regarding standard portions of cluster-management controllers, the underlying platform (such as KUBERNETES, as an example), platform API, platform networking, and so on. The developer's code can therefore focus on the new features but still make use of formal verification for how that code will work within an entire cluster-management system.

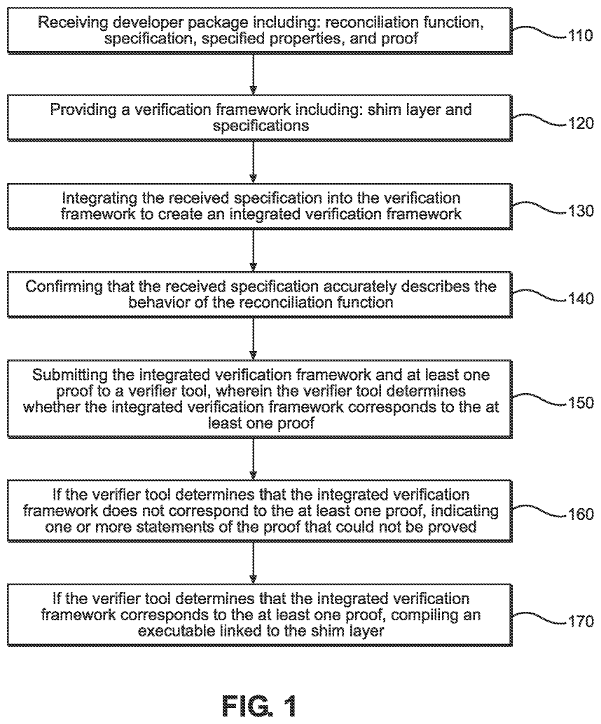

FIG. 1 provides a flowchart of an example method for providing a framework for building and verifying cluster-management controllers. At stage 110 of the example method, a developer can submit a developer package that includes a reconciliation function, specification, specified properties, and at least one proof. Each of these components is described in more detail herein. A reconciliation function can include a function that a cluster-management controller performs to reconcile the cluster to conform to a desired state. For example, a controller can execute a reconciliation function to examine a current state of the cluster, or a portion of the cluster, and make changes to get the system closer to the desired state. The reconciliation function can therefore include the code that the controller is intended to execute in the relevant cluster.

The specification in the developer package can be information describing the behavior of the reconciliation function using formal logic. For example, the specification can describe at an abstract level the steps that a controller should take based on one or more preconditions. The developer package can also include specified properties of the reconciliation function. For example, the specified properties can define properties indicating safety and/or liveness requirements for the specific controller. The specified properties themselves can vary from one controller to the next, based on the requirements set forth by the developer.

The developer package can also include at least one proof. The proof can be a formula, a portion of code, or a standalone file reflecting that the implementation of the controller guarantees the specified properties. Said another way, the proof can be code that proves there is no possible scenario where the specified properties are not appropriately met for the controller.

Stage 120 can include providing a verification framework for use with the developer package. Although presented as stage 120 in this example, providing the verification framework can occur before receiving any of the developer package in stage 110. Indeed, the verification framework is intended to be capable of analyzing multiple different developer packages that perform different functions in different contexts from one another. The verification framework can be specific to cluster-management controllers in the context of a specific cluster-management platform. For example, a first verification framework can be specific to cluster-management controllers from KUBERNETES, while another verification framework can be specific to a different cluster-management system.

The verification framework provides multiple components that a developer need not provide on their own to guarantee a controller. For example, the verification framework can include a shim layer and various specifications. The shim layer can be one or more libraries that intercept API calls and can perform actions on those intercepted calls. For example, the shim layer can change the API call, perform the operation itself, or redirect the operation to a different location. In this manner, the shim layer can provide an interface between the developer's code and the various specifications and libraries provided by the verification framework. For example, the shim layer can be configured to implement generic cluster-management controller functionality based on instructions generated by the developer's reconciliation function. The shim layer can be one or more files, including one or more executable files, maintained in a storage location accessible to the verification framework. Portions of the shim layer can be executed in response to intercepted API calls. For example, a first execution layer of the shim layer can listen for an API call from a developer's cluster-management controller. Based on receiving the API call, a second execution layer of the shim layer can interpret the API call and perform one or more actions based on the interpretation of the API call, such as by performing an action using a specification or library stored in the verification framework. In this way, the shim layer can provide an interface between the developer's code and the various specifications and libraries provided by the verification framework.

The verification framework can also include a specification that describes the behavior of the shim layer, such as by using formal logic. As with the other specifications described herein, this specification can be stored as a data file in a library associated with, or accessible by, the verification framework. The shim specification can describe, for example, how a controller sends messages to the control plane API, how it handles notifications about state changes from the control plane API, how it locally caches this information, and whether operations read from the cache or from the control plane API directly.

The verification framework can include other specifications describing other behavior. For example, it can include a specification for behavior of a control plane API. For example, the API specification can describe how the cluster state is represented and updated on the control plane side and common primitives or abstractions exposed by the control plane API to developers. In an example where the verification framework is specific to the KUBERNETES system, the specification can describe the behavior of the KUBERNETES API using formal logic.

Similarly, the verification framework can include a specification that describes the network behavior of a cluster, such as a KUBERNETES cluster in an example using that platform. For example, the network specification can describe how the system takes the messages sent out by the controller and delivers the messages to the control plane API and provide models for how messages can be delayed and machines can crash.

Although not shown in FIG. 1, the verification framework can also include lemmas about the common properties of the shim layer, control plane API, and/or network. Lemmas are understood to be any intermediary value or description of such a common property. As an example, a lemma can abstractly describe that the control plane API, if receiving message X, will perform action Y and send out message Z. These lemmas can be used by a developer when writing their proof.

Stage 130 of the example method can include integrating the received specification (from stage 110) into the verification framework to create an integrated verification framework. This can include, for example, storing the received specification alongside the other specifications provided by the verification framework, such that the received specification can be accessed by the verification framework. For example, the received specification can be stored at a location accessible by components of the verification framework. In some examples, this stage can include one or more verification checks on the received specification before integrating it into the verification framework.

For example, at stage 140 the framework can confirm that the received specification accurately describes the behavior of the reconciliation function received from the developer. In some examples, stage 140 occurs before, or as part of, stage 130. This stage can include, for example, utilizing one or more preconditions and associated postconditions from the specification. Generally, for a function with an input and an output, the precondition can require that the input satisfies some property. The postcondition can require that for a certain type of input, the output satisfies some different property. A verification tool of the verification framework can apply the preconditions and postconditions for the verification function and verify that the verification function matches the requirements of the specification received from the developer. In some examples, the received specification is integrated into the verification framework of stage 130 after performing the confirmation at stage 140. In other examples, the received specification is integrated first and then confirmed at stage 140 before the method proceeds to the following stages.

Stage 150 can include submitting the integrated verification framework and at least one proof received from the developer to a verification tool (also referred to as a verifier tool). The verification tool can determine whether the integrated framework corresponds to the at least one proof. In some examples, this stage is a refinement proof that proves that the specification matches the actual implementation of the reconciliation function in the context of the overall cluster platform. For example, stage 150 can include simulating different inputs, outputs, and variables in order to determine whether the developer's proof holds true. As an example, one portion of the proof may specify that the controller should never delete sensitive data stored in a particular storage location. In this example, stage 150 includes a determination that with certain input or under certain circumstances, the controller would delete sensitive data from that storage location. In that example, the integrated verification framework would not accurately correspond to the relevant proof, and the method would proceed to stage 160.

At stage 160, if the verification tool determines that the integrated verification framework does not correspond to the at least one proof, then the system can indicate that one or more statements of the proof could not be proved. This can include, for example, outputting a message with an indication of the particular statement or statements of the proof that could not be proved. Continuing the example explained in the preceding paragraph, the verification tool could output a message indicating that the portion of the proof regarding the controller never deleting sensitive data stored in a particular storage location could not be proved because there is a scenario in which the control does, in fact, delete that data.

In some examples, stage 160 includes generating a message to an administrator or the developer that includes information about any statements in the proof that were not able to be proved by the verification tool. This can include, for example, displaying a message on a graphical user interface (“GUI”) that the developer uses to interface with the verification framework. The message can include an identification of the statement or portion of the proof that was not able to be proved. The developer can then use this information to improve the content of the developer package and submit a revised package, beginning the method at stage 110 again.

In some examples, the verification tool determines at stage 150 that the integrated verification framework corresponds to the proof without any violations. In such an example, the method can proceed from stage 150 to stage 170, where the integrated verification framework takes further steps based on the verification. For example, the framework can cause a message to be displayed to the developer indicating that the proof was able to be proved by the framework. In another example, the framework triggers compiling of an executable file linked to the shim layer. The framework can return this executable file to the developer, such that it can be used to integrate the new controller into an existing real-world cluster.

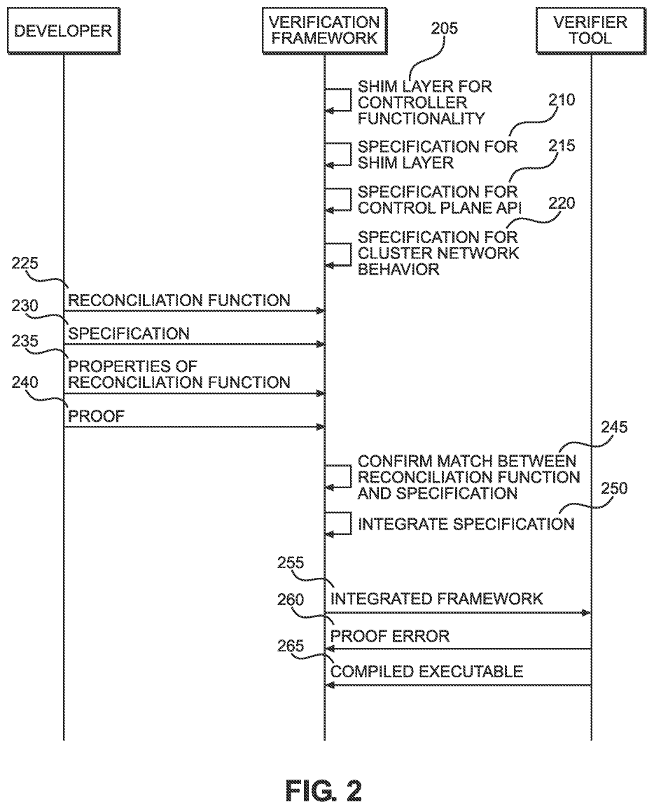

Turning to FIG. 2, a sequence diagram is provided of an example method for providing a framework for building and verifying cluster-management controllers. Stage 205 of the example method can include providing a shim layer for controller functionality. The verification framework provides multiple components that a developer need not provide on their own to guarantee a controller. For example, the verification framework can include a shim layer and various specifications. The shim layer can be one or more libraries that intercept API calls and can perform actions on those intercepted calls. For example, the shim layer can change the API call, perform the operation itself, or redirect the operation to a different location. In this manner, the shim layer can provide an interface between the developer's code and the various specifications and libraries provided by the verification framework. For example, the shim layer can be configured to implement generic cluster-management controller functionality based on instructions generated by the developer's reconciliation function. The shim layer can be one or more files, including one or more executable files, maintained in a storage location accessible to the verification framework. Portions of the shim layer can be executed in response to intercepted API calls. For example, a first execution layer of the shim layer can listen for an API call from a developer's cluster-management controller. Based on receiving the API call, a second execution layer of the shim layer can interpret the API call and perform one or more actions based on the interpretation of the API call, such as by performing an action using a specification or library stored in the verification framework. In this way, the shim layer can provide an interface between the developer's code and the various specifications and libraries provided by the verification framework.

At stage 210, the verification framework can include and provide a specification for the shim layer of stage 205. The shim specification describes the behavior of the shim layer, such as by using formal logic. As with the other specifications described herein, this specification can be stored as a data file in a library associated with, or accessible by, the verification framework. The shim specification can describe, for example, how a controller sends messages to the control plane API, how it handles notifications about state changes from the control plane API, how it locally caches this information, and whether operations read from the cache or from the control plane API directly.

At stage 215, the verification framework can include and provide a specification for the control plane API. The API specification can use formal logic to describe behavior of a control plane API associated with the relevant platform that the controller was designed for. For example, the API specification can describe how the cluster state is represented and updated on the control plane side and common primitives or abstractions exposed by the control plane API to developers. In an example where the verification framework is specific to the KUBERNETES system, the specification can describe the behavior of the KUBERNETES API using formal logic.

At stage 220, the verification framework can include and provide a specification for the cluster's network behavior and overall asynchrony of the distributed system. For example, the network specification can describe how the system takes the messages sent out by the controller and delivers the messages to the control plane API, and provide models for how messages can be delayed and machines can crash. The network specification can use formal logic to describe the network behavior of a cluster of the relevant system, such as a KUBERNETES cluster in an example where the developer's controller is intended for use in a KUBERNETES system.

Although not shown in FIG. 2, the verification framework can also include lemmas about the common properties of the shim layer, control plane API, and/or network. Lemmas are understood to be any intermediary value or description of such a common property. As an example, a lemma can abstractly describe that the control plane API, if receiving message X, will perform action Y and send out message Z. These lemmas can be used by a developer when writing their proof.

At stage 225, the developer can submit a reconciliation function to the verification framework. This stage, as well as stages 230 through 240, can be performed by uploading one or more files to a platform associated with the verification framework. In one example, a user interface is provided that allows the developer to upload and submit their files. The interface can allow the developer to select a type of cluster that the files are intended for, as well as other options such as selecting between types of controllers that the files are intended to reflect.

The reconciliation function can include a function that a cluster-management controller performs to reconcile the cluster to conform to a desired state. For example, a controller can execute a reconciliation function to examine a current state of the cluster, or a portion of the cluster, and make changes to get the system closer to the desired state. The reconciliation function can therefore include the code that the controller is intended to execute in the relevant cluster.

At stage 230, the developer can submit a specification. The specification can be information describing the behavior of the reconciliation function using formal logic. For example, the specification can describe at an abstract level the steps that a controller should take based on one or more preconditions and/or postconditions.

At stage 235, the developer can submit specified properties of the reconciliation function. For example, the specified properties can define properties indicating safety and/or liveness requirements for the specific controller. The specified properties themselves can vary from one controller to the next, based on the requirements set forth by the developer.

At stage 240, the developer can submit one or more proofs. A proof can be a formula, a portion of code, or a standalone file reflecting that the implementation of the controller guarantees the specified properties. Said another way, the proof can be code that proves there is no possible scenario where the specified properties are not appropriately met for the controller.

In some examples, the submissions from the developer at stages 225 through 240 can be provided at the same time, such as by submitting a developer package that includes the reconciliation function, specification, specified properties, and proof.

At stage 245, the verification framework can confirm that the reconciliation function matches the specification. In some examples, the verifier tool can perform this confirmation. The framework or tool can determine whether the received specification accurately describes the behavior of the reconciliation function received from the developer. This stage can include, for example, utilizing one or more preconditions and associated postconditions from the specification. Generally, for a function with an input and an output, a precondition can require that the input satisfies some property. A postcondition can require that for a certain type of input, the output satisfies some different property. A verification tool of the verification framework can apply the preconditions and postconditions for the verification function and verify that the verification function matches the requirements of the specification received from the developer.

At stage 250, the verification framework can integrate the specification received from the developer to create an integrated verification framework. This can include, for example, storing the received specification alongside the other specifications provided by the verification framework, such that the received specification can be accessed by the verification framework. For example, the received specification can be stored at a location accessible by components of the verification framework. In some examples, this stage can include a precondition that stage 245 results in confirmation of a match between the reconciliation function and the received specification before performing the integration at stage 250.

Stage 255 can include submitting the integrated verification framework and at least one proof received from the developer to a verification tool (also referred to as a verifier tool). The verification tool can determine whether the integrated framework corresponds to the at least one proof. In some examples, this stage is a refinement proof that proves that the specification matches the actual implementation of the reconciliation function in the context of the overall cluster platform. For example, the verification tool can simulate different inputs, outputs, and variables in order to determine whether the developer's proof holds true for the controller. As an example, one portion of the proof may specify that the controller should never delete sensitive data stored in a particular storage location. In that example, the verification tool determines that with certain input or under certain circumstances, the controller would delete sensitive data from that storage location. In that case, the integrated verification framework would not accurately correspond to the relevant proof, and the method would proceed to stage 260. On the other hand, if the integrated verification framework is accurate, the method can proceed to stage 265.

At stage 260, the verification tool can output a proof error message or alert. If the verification tool determines that the integrated verification framework does not correspond to the at least one proof, then the system can indicate that one or more statements of the proof could not be proved. This can include, for example, outputting a message with an indication of the particular statement or statements of the proof that could not be proved. Continuing the example explained in the preceding paragraph, the verification tool could output a message indicating that the portion of the proof regarding the controller never deleting sensitive data stored in a particular storage location could not be proved because there is a scenario in which the control does, in fact, delete that data.

In some examples, stage 260 includes generating a message to an administrator or the developer that includes information about any statements in the proof that were not able to be proved by the verification tool. This can include, for example, displaying a message on a GUI that the developer uses to interface with the verification framework. The message can include an identification of the statement or portion of the proof that was not able to be proved. The developer can then use this information to improve the content of the developer package and submit a revised package, beginning the method at stage 225 again.

On the other hand, if the integrated verification framework is accurate, the method can proceed to stage 265. For example, the framework can cause a message to be displayed to the developer indicating that the proof was able to be proved by the framework. In another example, the framework triggers compiling of an executable file linked to the shim layer. The framework can return this executable file to the developer, such that it can be used to integrate the new controller into an existing real-world cluster.

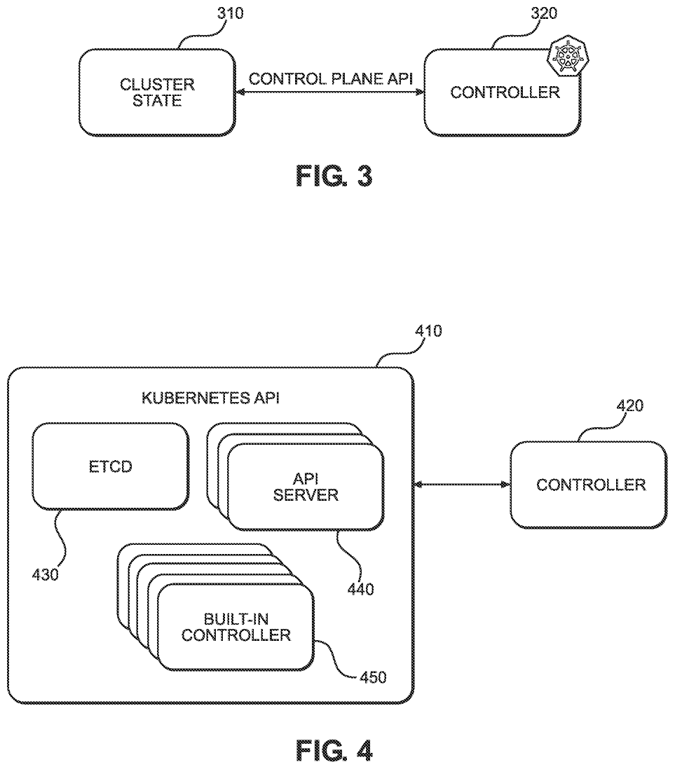

FIG. 3 is a diagram of an example cluster-management controller implementing state reconciliation. The cluster state 310 can include stored objects representing containers, volumes, nodes, applications, and any other components of a distributed system. The controller 320 can be an executable version of the code that a developer provides to a verification framework for safety and liveness verification. The controller 320 can utilize a control plane API to observe the cluster state 310 and compare it to a desired state. If the controller 320 recognizes a discrepancy between the cluster state 310 and the desired state, the controller 320 can take one or more actions to reconcile these states by changing the cluster state 310 to match the desired state more closely. The controller 320 can accomplish this by executing the reconciliation function in an example.

FIG. 4 is a diagram of an example cluster-management controller interfacing with components of an example KUBERNETES cluster. In this example, the KUBERNETES API 410 includes various components with which the controller 420 can interface using appropriate API calls. These components include, for example, a storage system 430, labeled “etcd” to reflect the naming convention of the KUBERNETES system. The components can also include an API server 440 configure to receive and respond to API calls, such as API calls from the controller 420. The API server 440 and storage system 430 can operate together to form a databases system that stores objects describing components of the cluster, such as containers, nodes, volumes, as well as a mechanism for retrieving these objects and returning them to a requesting controller 420.

The built-in controller 450 can perform core functionality associated with the KUBERNETES API, such as making changes to objects stored in the storage system 430. The built-in controller 450 can be a controller that is provided with the KUBERNETES platform, as opposed to the controller 420 created by a developer and verified as described herein. The built-in controller 450 can perform actions such as deleting, moving, or otherwise manipulating objects in the storage system 430 based on communications received at the API server 440, for example.

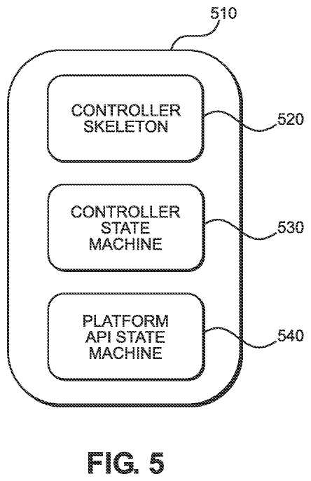

FIG. 5 is a diagram showing components of an example framework for building and verifying cluster-management controllers. The framework 510 of FIG. 5 can be the same verification framework described above. As shown, the framework 510 can include three abstractions of components 520, 530, and 540. The controller skeleton 520 can be a layer that a developer can build a new controller on top of. The controller skeleton 520 can translate the implementation of a controller into a specification that uses formal logic. The specification can later be used in a proof. The controller skeleton 520 is not specific to any particular reconcile function-instead, a developer can provide the reconcile function that they wish their controller to execute.

The framework 510 of FIG. 5 also includes a controller state machine 530. The controller state machine 530 can include specifications relating to controller behavior. For example, the specification can describe how a controller in a particular cluster-management platform behaves, especially when interacting with a controller. The controller state machine 530 is not specific to a controller being built by a developer. Instead, it describes core controller behavior that any controller in the platform would perform or be capable of performing.

The framework 510 also includes a platform API state machine 540. The platform API state machine 540 can include specification of the API behavior for the system. For example, the specification can provide detail regarding how the API is expected to behave, especially when interacting with a controller. Here again, the platform API state machine 540 is not specific to a particular controller being built by a developer. Instead, it applies to API behavior across all controllers in the platform. The controller skeleton 520, controller state machine 530, and platform API state machine 540 can collectively be considered a verification framework as described above.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for verifying properties of a cluster management controller, comprising:
receiving a reconciliation function that reflects an implementation of the cluster management controller;
receiving a specification that describes the behavior of the reconciliation function using formal logic;
receiving specified properties of the reconciliation function;
receiving at least one proof reflecting that the implementation of the cluster management controller guarantees the specified properties;
providing a verification framework comprising:
a shim layer that implements generic cluster management controller functionality;
a specification for the behavior of the shim layer;
a specification for behavior of a control plane Application Programming Interface (“API”);
a specification for the network behavior of the cluster;
integrating the received specification into the verification framework to create an integrated verification framework; and
submitting the integrated verification framework and the at least one proof to a verifier tool, wherein the verifier tool determines whether the integrated verification framework corresponds to the at least one proof.

2. The method of claim 1, further comprising confirming that the received specification accurately describes the behavior of the reconciliation function.

3. The method of claim 1, wherein providing the verification framework includes providing information about the common properties of the shim layer, control plane API, and network behavior.

4. The method of claim 3, wherein the information about the common properties of the shim layer, control plane API, and network behavior comprises a plurality of lemmas to be used in constructing the at least one proof.

5. The method of claim 1, further comprising, if the verifier tool determines that the integrated verification framework does not correspond to the at least one proof, indicating one or more statements of the proof that could not be proved.

6. The method of claim 1, further comprising, if the verifier tool determines that the integrated verification framework corresponds to the at least one proof, compiling an executable linked to the shim layer.

7. The method of claim 1, wherein the verification framework is specific to cluster management controllers.

8. A non-transitory, computer-readable medium containing instructions that, when executed by a hardware-based processor, cause the processor to perform stages for verifying properties of a cluster management controller, the stages comprising:
receiving a reconciliation function that reflects an implementation of the cluster management controller;
receiving a specification that describes the behavior of the reconciliation function using formal logic;
receiving specified properties of the reconciliation function;
receiving at least one proof reflecting that the implementation of the cluster management controller guarantees the specified properties;
providing a verification framework comprising:
a shim layer that implements generic cluster management controller functionality;
a specification for the behavior of the shim layer;
a specification for behavior of a control plane Application Programming Interface (“API”);
a specification for the network behavior of the cluster;
integrating the received specification into the verification framework to create an integrated verification framework; and
submitting the integrated verification framework and the at least one proof to a verifier tool, wherein the verifier tool determines whether the integrated verification framework corresponds to the at least one proof.

9. The non-transitory, computer-readable medium of claim 8, the stages further comprising confirming that the received specification accurately describes the behavior of the reconciliation function.

10. The non-transitory, computer-readable medium of claim 8, wherein providing the verification framework includes providing information about the common properties of the shim layer, control plane API, and network behavior.

11. The non-transitory, computer-readable medium of claim 10, wherein the information about the common properties of the shim layer, control plane API, and network behavior comprises a plurality of lemmas to be used in constructing the at least one proof.

12. The non-transitory, computer-readable medium of claim 8, the stages further comprising, if the verifier tool determines that the integrated verification framework does not correspond to the at least one proof, indicating one or more statements of the proof that could not be proved.

13. The non-transitory, computer-readable medium of claim 8, the stages further comprising, if the verifier tool determines that the integrated verification framework corresponds to the at least one proof, compiling an executable linked to the shim layer.

14. The non-transitory, computer-readable medium of claim 8, wherein the verification framework is specific to cluster management controllers.

15. A system for verifying properties of a cluster management controller, comprising:
a memory storage including a non-transitory, computer-readable medium comprising instructions; and
a hardware-based processor that executes the instructions to carry out stages comprising:
receiving a reconciliation function that reflects an implementation of the cluster management controller;
receiving a specification that describes the behavior of the reconciliation function using formal logic;
receiving specified properties of the reconciliation function;
receiving at least one proof reflecting that the implementation of the cluster management controller guarantees the specified properties;
providing a verification framework comprising:
a shim layer that implements generic cluster management controller functionality;
a specification for the behavior of the shim layer;
a specification for behavior of a control plane Application Programming Interface (“API”);
a specification for the network behavior of the cluster;
integrating the received specification into the verification framework to create an integrated verification framework; and
submitting the integrated verification framework and the at least one proof to a verifier tool, wherein the verifier tool determines whether the integrated verification framework corresponds to the at least one proof.

16. The system of claim 15, the stages further comprising confirming that the received specification accurately describes the behavior of the reconciliation function.

17. The system of claim 15, wherein providing the verification framework includes providing information about the common properties of the shim layer, control plane API, and network behavior.

18. The system of claim 17, wherein the information about the common properties of the shim layer, control plane API, and network behavior comprises a plurality of lemmas to be used in constructing the at least one proof.

19. The system of claim 15, the stages further comprising, if the verifier tool determines that the integrated verification framework does not correspond to the at least one proof, indicating one or more statements of the proof that could not be proved.

20. The system of claim 15, the stages further comprising, if the verifier tool determines that the integrated verification framework corresponds to the at least one proof, compiling an executable linked to the shim layer.
